(19) United States
(12) Patent Application Publication
(10) Pub. No.: US 2026/0259335 A1
(43) Pub. Date: Sep. 3, 2026

(54) REAL-TIME SUBSURFACE MONITORING USING MONOCHROMATIC SOURCE AND PHASE VARIATION

(71) Applicant: Chevron U.S.A. Inc., San Ramon, CA (US)

(72) Inventors: Noel Milad Bader, Richmond, TX (US); Ivan Lim Chen Ning, Houston, TX (US); Kurt Toshimi Nihei, Oakland, CA (US); Bryan Harvey, Conroe, TX (US)

(21) Appl. No.: 19/066,783

(22) Filed: Feb. 28, 2025

(51) Int. Cl. G01V 1/00; G01V 1/30

(52) U.S. Cl. CPC G01V 1/005; G01V 1/307; G01V 2210/1295; G01V 2210/1429; G01V 2210/63

(57) ABSTRACT

A monochromatic seismic source and seismic receivers are used to monitor the real-time dynamic behavior of a subsurface region. A seismic source is used to emit a monochromatic wave into the subsurface region and multiple seismic receivers are positioned within the subsurface region to receive the monochromatic wave. Phase variations in the monochromatic wave are measured using a phase-sensitive detection tool and the phase variations are used to determine changes in subsurface properties of the subsurface region.

### FIELD

The present disclosure relates generally to the field of monitoring subsurface properties using monochromatic source and phase variation.

### BACKGROUND

Accurately monitoring properties of a subsurface region, such as fracture generation and propagation, presence/movement of fluid (e.g., water, oil), and pressure is important to efficiently recovering resource (e.g., hydrocarbon) from the subsurface region and reducing development costs.

### SUMMARY

This disclosure relates to monitoring subsurface properties. A seismic source may be configured to emit a monochromatic wave into a subsurface region. Seismic receivers may be configured to receive the monochromatic wave after the monochromatic wave has traveled through the subsurface region. Phase variations in the monochromatic wave received by the seismic receivers may be monitored using a phase-sensitive detection tool. Changes in one or more properties of the subsurface region may be determined based on the phase variations in the monochromatic wave received by the seismic receivers and/or other information.

A system for structural inspection may include one or more seismic sources, multiple seismic receivers, one or more electronic storage, one or more processors and/or other components. The electronic storage may store information relating to a subsurface region, information relating to properties of the subsurface region, information relating to a seismic source, information relating to a seismic receiver, information relating to a monochromatic wave, information relating to phase variations in the monochromatic wave, information relating to a phase-sensitive detection tool, and/or other information.

A seismic source may be configured to emit a monochromatic wave into a subsurface region. A seismic receiver may be configured to receive the monochromatic wave after the monochromatic wave has traveled through the subsurface region. Different seismic receivers may be configured to receive the monochromatic wave after the monochromatic wave has traveled through different parts of the subsurface region.

In some implementations, the seismic receivers may be positioned vertically and/or horizontally within the subsurface region.

The processor(s) may be configured by machine-readable instructions. Executing the machine-readable instructions may cause the processor(s) to facilitate monitoring subsurface properties. The machine-readable instructions may include one or more computer program components. The computer program components may include one or more of a phase component, a property component, and/or other computer program components.

The phase component may be configured to monitor phase variations in the monochromatic wave received by the seismic receivers. The phase variations in the monochromatic wave received by the seismic receivers may be monitored using a phase-sensitive detection tool.

In some implementations, the use of the phase-sensitive detection tool to monitor the phase variations in the monochromatic wave received by the seismic receivers may include variation in phase of a reference signal to lock phase of the monochromatic wave received by the seismic receivers. In some implementations, the use of the phase-sensitive detection tool to monitor the phase variations in the monochromatic wave received by the seismic receivers may include an increase in size of a correlation length to increase sensitivity to the monochromatic wave received by the seismic receivers.

The property component may be configured to determine changes in one or more properties of the subsurface region. The changes in the propert(ies) of the subsurface region may be determined based on the phase variations in the monochromatic wave received by the seismic receivers and/or other information. In some implementations, the propert(ies) of the subsurface region include rock properties and/or other properties of the subsurface region. In some implementations, the changes in the propert(ies) of the subsurface region may be caused by fluid injection. In some implementations, the fluid injection may include hydraulic stimulation.

In some implementations, locations of the changes in the propert(ies) of the subsurface region may be determined. In some implementations, characteristics of the changes in the propert(ies) of the subsurface region may be determined.

In some implementations, production in the subsurface region may be facilitated based on the changes in the propert(ies) of the subsurface region, determined based on the phase variations in the monochromatic wave received by the seismic receivers, and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for monitoring subsurface properties.

FIG. 2 illustrates an example method for monitoring subsurface properties.

FIG. 3 illustrates an example deployment of a seismic source and seismic receivers for a subsurface region.

FIG. 4A illustrates example phase changes measured over a horizontal fiber.

FIG. 4B illustrates example phase changes measured over a vertical fiber.

FIG. 5A illustrates example phase changes measured over different parts of a horizontal fiber.

FIG. 5B illustrates example phase changes measured over different parts of a vertical fiber.

### DETAILED DESCRIPTION

The present disclosure relates to monitoring subsurface properties. A monochromatic seismic source and seismic receivers are used to monitor the real-time dynamic behavior of a subsurface region. A seismic source is used to emit a monochromatic wave into the subsurface region and multiple seismic receivers are positioned within the subsurface region to receive the monochromatic wave. Phase variations in the monochromatic wave are measured using a phase-sensitive detection tool and the phase variations are used to determine changes in subsurface properties of the subsurface region.

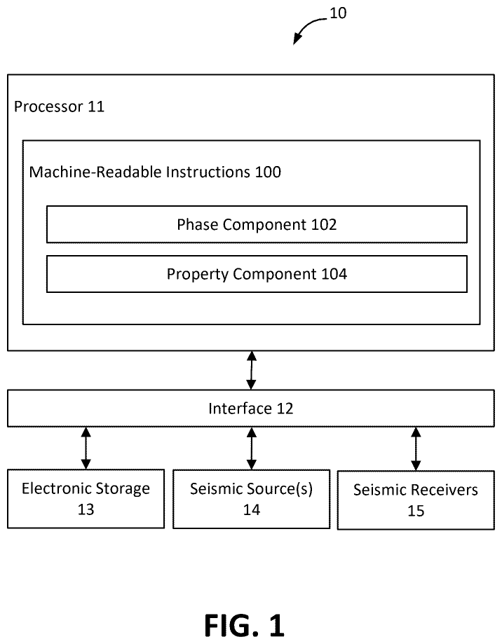

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, one or more seismic sources 14, seismic receivers 15, and/or other components. The seismic source(s) 14 may be configured to emit one or more monochromatic waves into a subsurface region. The seismic receivers 15 may be configured to receive the monochromatic wave(s) after the monochromatic wave(s) have traveled through the subsurface region. Phase variations in the monochromatic wave(s) received by the seismic receivers 15 may be monitored using a phase-sensitive detection tool. Changes in one or more properties of the subsurface region may be determined based on the phase variations in the monochromatic wave(s) received by the seismic receivers 15 and/or other information.

The electronic storage 13 may include one or more electronic storage media that electronically stores information. The electronic storage 13 one or more non-transient computer-readable media. The electronic storage 13 may store software algorithms, information determined by the processor 11, information received remotely, and/or other information that enables the system 10 to function properly. For example, the electronic storage 13 may store information relating to a subsurface region, information relating to properties of the subsurface region, information relating to a seismic source, information relating to a seismic receiver, information relating to a monochromatic wave, information relating to phase variations in the monochromatic wave, information relating to a phase-sensitive detection tool, and/or other information.

A subsurface region may refer to a part of earth located beneath the surface/located underground. A subsurface region may refer to a part of earth that is not exposed at the surface of the ground.

A seismic source may refer to a device configured to generate and emit seismic energy. The seismic energy generated by the seismic source may be used to examine, inspect, and/or investigate a subsurface region. A seismic source may generate and emit seismic energy acoustically, mechanically, and/or through other forms of energy.

A seismic source may be configured to generate and emit one or more seismic waves into a subsurface region. A seismic source may be configured to generate and emit one or more monochromatic waves into a subsurface region. A monochromatic wave may refer to a seismic wave with a constant frequency. A monochromatic wave may refer to a seismic wave with a single frequency that does not change over time or space. A monochromatic wave may include a sinusoidal wave.

The phase-sensitive detection of the present disclosure may measure the phase difference (relative phase) between a reference seismic wave (reference signal) and a monitoring seismic wave (monitoring signal) at a moment in time, and the changes in the phase differences (relative phases) over different moments in time may be used to determine changes in the subsurface region (changes in subsurface propert(ies)).

If the seismic source cannot maintain a stable frequency over time, the phase retrieval of the present disclosure may still work as long as the frequency changes slowly over time and the reference and monitoring signals exhibit the same frequency behavior. The phase retrieval of the present disclosure may still work with changes in frequency over time as long as the apparent phase variation caused by the change in frequency is smaller than the subsurface-related phase variation to be detected.

A seismic source may be configured to generate and emit continuous or non-continuous waves. A seismic source may be configured to generate and emit continuous, monochromatic wave (e.g., fully continuous), and/or non-continuous, monochromatic wave (e.g., continuous for a short period, which is repeated for time-lapse acquisitions), and/or other types of waves. The phase-sensitive detection tool of the present disclosure may accurately determine phase variations over discrete time steps as long as the phase variations do not exceed 2π between two consecutive steps and the baseline signal does not undergo a subsurface-related phase change.

A seismic receiver may refer to a device configured to receive seismic energy. A seismic receiver may be configured to receive one or more seismic waves after the seismic wave(s) have traveled through a subsurface region. A seismic receiver may be configured to receive the monochromatic wave after the monochromatic wave has traveled through the subsurface region. Examples of seismic receivers include geophones, fiber optics, microphones, and accelerometers. Multiple seismic receivers may be positioned within a subsurface region to receive seismic waves emitted by one or more seismic sources. For example, multiple seismic receivers may be positioned vertically and/or horizontally within the subsurface region. For instance, multiple seismic receivers may be positioned along vertical and/or horizontal wells. Different seismic receivers may be configured to receive the seismic waves (e.g., monochromatic waves) after the seismic waves have traveled through different parts of the subsurface region. The received seismic waves may be used to determine the properties/changes in the properties of the subsurface region through which the seismic waves traveled. Transmission and reception of seismic waves that travel through different parts of the subsurface region may be used to constrain/pinpoint in space where and what types of changes are occurring in the subsurface region.

The seismic sources and the seismic receivers may be used to emit seismic waves through a subsurface region and receive the seismic waves at different times. The seismic waves measured at different times may be used to determine changes (types, amounts, and/or locations of changes) in the subsurface region.

A single instance of seismic wave measurement (a single survey) may include measurement of a reference seismic wave (reference signal) and measurement of a monitoring seismic wave (monitoring signal). The reference signal and the monitoring signal from a single seismic source may be measured at the same time. The reference signal and the monitoring signal from a single seismic source may be measured from different locations by different seismic receivers. The reference signal and the monitoring signal from a single seismic source may be measured for comparison to determine the phase difference (relative phase) for the survey. The reference signal may be the signal input to the seismic source for seismic wave generation. The reference signal may be measured by a seismic receiver close to the seismic source (e.g., a seismic receiver located within a threshold distance of the seismic source, such as a few meters, the seismic receiver closest to the seismic source). The monitoring signals may be measured by seismic receivers away from the seismic source. The monitoring signals may be measured by seismic receivers positioned away from the seismic source such that the source-receiver wave path crosses a zone of interest in the subsurface region where seismic velocities are expected to change over time due to activities in the subsurface region (e.g., hydraulic fracturing, fluid injection, production, changes in the state of stress). The reference signal and the monitoring signal measured during a survey may be compared to determine the phase difference (relative phase) between the reference and monitoring signals for the survey.

Surveys may be conducted at different moments in time with the seismic source and the seismic receivers in their locations. The locations of the seismic source and the seismic receivers may not be changed between the surveys. The phase differences (relative phases) measured at different moments in time may be compared to determine changes in the relative phase of the reference signal and the monitoring signal. The reference signal and the monitoring signal from a single seismic source may be measured for comparison to determine the phase difference (relative phase) for the survey. The variations in the phase differences across surveys may be used to determine the properties in the subsurface region/changes in the properties in the subsurface region. For example, one survey may be conducted at one moment in time, with the seismic wave traveling through a part of the subsurface region. Another survey may be conducted at a later moment in time, with the seismic wave traveling through the same part of the subsurface region. The variations in the phase differences between the reference signal and the monitoring signal measured during the two surveys may be used to determine changes in the inspected/investigated part of the subsurface region between the two surveys.

The seismic sources and the seismic receivers may be used to perform subsurface monitoring. For example, the seismic sources and the seismic receivers may be continuously active, enabling continuous and real-time monitoring of a surface region. The seismic sources and the seismic receivers may be active at discrete time steps, enabling non-continuous (e.g., periodic) monitoring of a surface region. The phase variations over the discrete time steps may be measured accurate as long as the phase variations do not exceed 2π between two consecutive steps, and the baseline signal does not undergo a subsurface-related phase change.

Monitoring properties (changes in properties) of a subsurface region is important for development of the subsurface region and for production from the subsurface region. For example, monitoring hydraulic stimulation of an unconventional reservoir (e.g., characterizing induced hydraulic fractures their interaction with reservoir rock, and their impact on stimulated rock volume) is important to reduce development costs and improve hydrocarbon recovery from the reservoir.

Existing techniques to monitor properties in a subsurface region using seismic energy (seismic survey) may be only sensitive to strong effects of hydraulic fractures on seismic velocities due to the bandlimited nature of the employed seismic waves. Small changes in the subsurface properties may be beneath the sensitivity of seismic surveys. Hydraulic fractures' effect on seismic velocities may be below the sensitivity (detectability level) of conventional seismic surveys.

The present disclosure provides an improved seismic survey with increased sensitivity. The improved seismic survey of the present disclosure may include a phase-sensitive detection tool that increases sensitivity of the seismic survey. Monochromatic waves may be used to monitor in real-time the dynamic behavior of hydraulic fractures in the subsurface region. The phase-sensitive detection tool may be used to detect variations in the phase of the monochromatic wave due to perturbations in seismic velocities along the source-receiver path. The perturbations may be below the seismic resolution and its effect on the seismic phase may be below the temporal sampling of measurement. Small changes in subsurface properties (changes less than 1%) may be detected using the present disclosure. The phase-sensitive detection tool may be used to retrieve sub-sampling time shifts in the presence of overwhelming noise. For example, the present disclosure may increase the resolution of the seismic survey by a factor of 10 to 100 and allow for greater noise compensation.

The steps of the present disclosure may include: (1) designing the source-receiver geometry to illuminate a target region of interest, (2) selecting a temporal frequency for individual seismic sources, (3) emitting monochromatic waves from the seismic sources and measuring, via seismic receivers, the monochromatic waves before, during, and after hydraulic stimulation, (4) processing the measurements in real time by using the phase-sensitive detection tool to extract phase variations of the monochromatic waves with time, (5) mapping the phase variations in space to track seismic velocities perturbations in real-time, and (6) determining properties/changes in properties of the subsurface region using the tracked seismic velocities perturbations.

The present disclosure may be used to detect hydraulic fractures' effect on seismic velocities (e.g., due to fracture propagation, fluid substitution, change in stress field). Characterization of the subsurface region (e.g., determining properties in different parts of the subsurface region, locating and determining types and/or amounts of changes in properties) may be used to improve development of and production from the subsurface region. Ray-based tomography may be used to build a velocity model for the subsurface region. For example, multiple seismic receivers may be used to receive a monochromatic wave from a single seismic source, and the phase variations may be measured between pairs of receivers to provide dense spatial coverage. The phase variations along different paths of wave travel may be leveraged to perform imaging or tomography (inversion) to build time-lapse two-dimensional or three-dimensional wave speed volumes.

Other advantages of the present disclosure include reduced processing costs/minimal processing, reduce cost of seismic survey implementation (able to use seismic sources less powerful than conventional seismic surveys), ability to accommodate different signal-to-noise levels via averaging, real-time monitoring of subsurface regions with a lag only due to wave propagation time and averaging window (order of seconds), real-time monitoring of subsurface regions with on-the-fly phase change detection, and no source repeatability issue between baseline and monitoring when continuous waves are used (source need not be shut off and on).

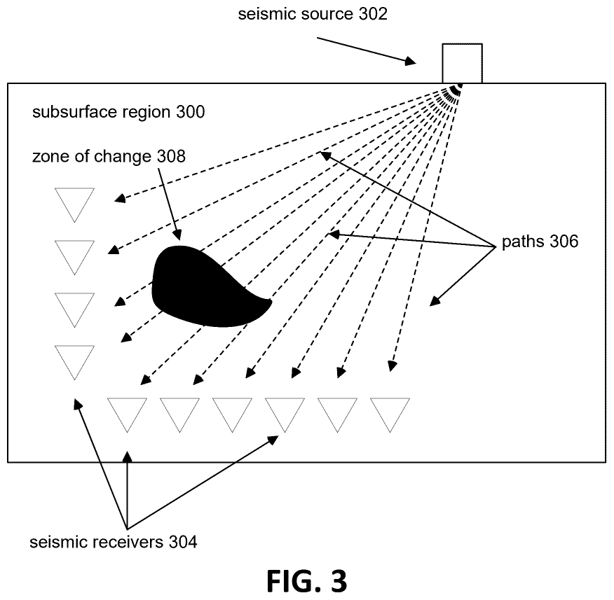

FIG. 3 illustrates an example deployment of a seismic source 302 and seismic receivers 304 for a subsurface region 300. The seismic source 302 may be located at the top of the subsurface region 300. The seismic receivers 304 may be located along a well. For example, the seismic receivers 304 may include different parts of fiber(s) running along vertical and horizontal sections of the well. The seismic source 302 may emit a monochromatic wave into the subsurface region 300. The monochromatic wave may travel over different paths 306 before reaching the seismic receivers 304. Some of the paths 306 may go through a zone of change 308. The zone of change 308 may include a region where seismic velocities change over time. The seismic velocities may change due to activity in the subsurface region 300 (e.g., hydraulic stimulation, fluid injection). The monochromatic wave that traveled through the zone of change 308 may experience change in phase. Phase variations in seismic waves measured by the seismic receivers 304 may be used to determine the location (position, size, shape) of the zone of change 308 and to determine the types and/or the amounts changes happening inside the zone of change 308.

The phase variations in seismic waves measured by the seismic receivers 304 may be used to characterize the subsurface properties/changes in the subsurface properties. For example, fractures in the subsurface region 300 may be quantified (e.g., is a fracture opening or closing, is fluid flowing through a fracture, is pore pressure changing inside a fracture, is fluid content changing inside a fracture, is water saturation changing inside a fracture). As another example, water sweeping in the subsurface region 300 may be quantified (e.g., where and how water/oil is moving within the subsurface region 300). The subsurface properties/changes in the subsurface properties may be used to develop the subsurface region 300 (e.g., determine number, types, and/or locations of equipment to be installed in the reservoir, plan well completion) and/or to perform production in the subsurface region 300 (e.g., determine how wells are operated for production). The subsurface properties/changes in the subsurface properties may be used to assess risks in performing different activity in the subsurface region 300.

While a single seismic source is shown in FIG. 3, this is merely an example and is not meant to be limiting. For example, multiple seismic sources may be used to increase the spatial coverage of subsurface monitoring. Different seismic sources may emit monochromatic waves at different frequencies to distinguish/separate the different seismic sources in the recorded signals.

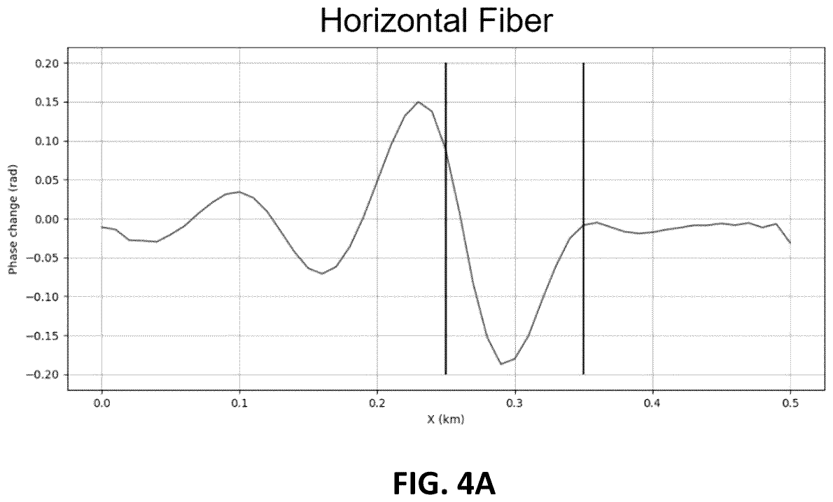

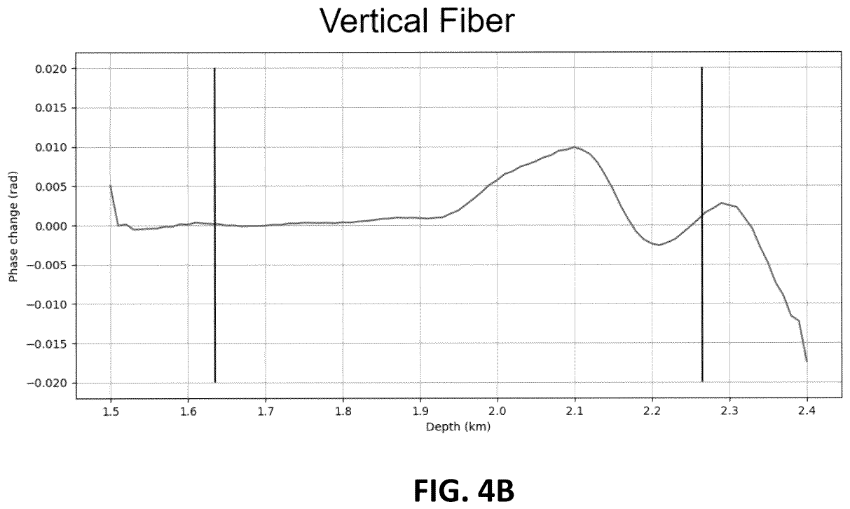

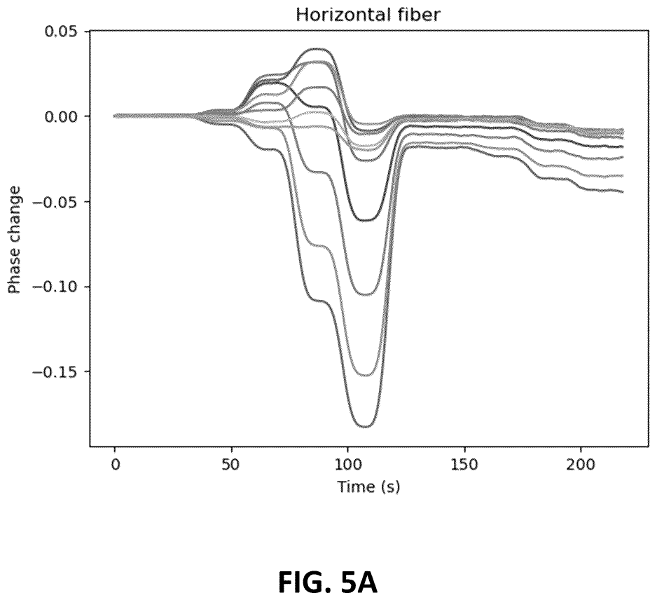

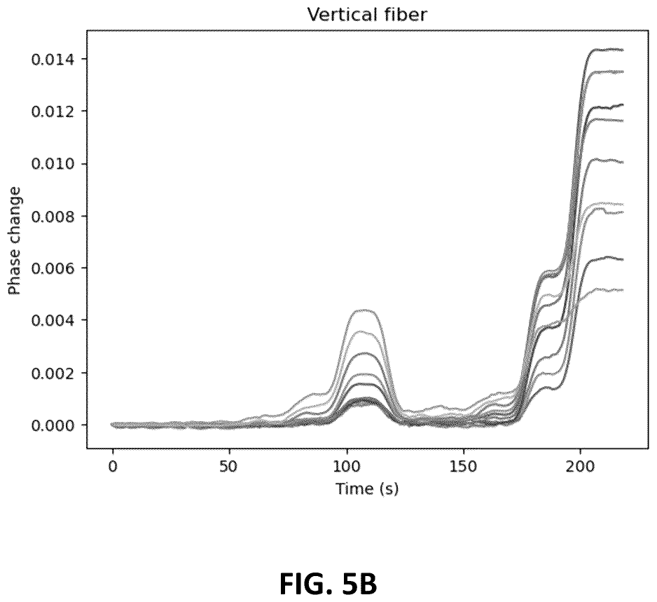

Seismic receivers located in different parts of a subsurface region may record different phase changes. FIG. 4A illustrates example phase changes measured over a horizontal fiber. FIG. 4B illustrates example phase changes measured over a vertical fiber. FIGS. 4A and 4B show changes in phase over a distance. FIG. 5A illustrates example phase changes measured over different parts of a horizontal fiber. FIG. 5B illustrates example phase changes measured over different parts of a vertical fiber. FIGS. 5A and 5B show changes in phase over time.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate monitoring subsurface properties. The machine-readable instructions 100 may include one or more computer program components. The machine-readable instructions 100 may include a phase component 102, a property component 104, and/or other computer program components.

The phase component 102 may be configured to monitor phase variations in the seismic waves received by the seismic receivers 15. The phase component 102 may be configured to monitor phase variations in the monochromatic waves received by the seismic receivers 15. Phase variations in a seismic wave may refer to changes in the phase of the seismic wave. Phase variations in a seismic wave may refer to changes in the timing of the seismic wave. Phase variations in a seismic wave may refer to shifts in the seismic wave. Phase variations in a seismic wave may be caused by changes in one or more properties of the subsurface region through which the seismic wave traveled. Deviation of the phase of the seismic wave from the baseline measurement may indicate that one or more properties have changed in the subsurface region.

Monitoring phase variations in the seismic waves (e.g., monochromatic waves) may include one or more of checking, examining, tracking, observing, watching, and/or otherwise monitoring the phase variations. The phase variations may be monitored as the seismic waves are received by the seismic receiver 15. The phase variations may be monitored continuously/periodically. The phase variations may be monitored based on user/computing system command.

The phase variations in a seismic wave received by a seismic receiver may be monitored by (1) comparing the seismic wave received by the seismic receiver (monitoring seismic wave) with a reference seismic wave (seismic wave output by the seismic source, seismic wave received by a seismic receiver close to the seismic source) to determine the relative phase between the monitoring seismic wave and the reference seismic wave (relative phase from an initial survey), and (2) comparing the relative phases from different surveys. The phase variations in a seismic wave received by the seismic receivers 15 may be monitored by comparing the relative phase from different surveys to determine whether and how the relative phase has changed between the monitoring seismic wave and the reference seismic wave over time.

The phase variations in the seismic waves received by the seismic receivers 15 may be monitored using a phase-sensitive detection tool. The phase of the seismic wave may be unknown, and the phase-sensitive detection tool may be used to determine the phase of the seismic wave. The phase-sensitive detection tool may enable detection of phase changes at smaller resolution than conventional phase measurements. The phase-sensitive detection tool may amplify the phase changes in the seismic waves.

The phase-sensitive detection tool may determine the relative phase between two seismic waves (signals conveying information about the waves) at a given frequency. The change in the relative phase may be detected in real time, enabling time-lapse subsurface monitoring using monochromatic seismic sources. The phase-sensitive detection tool may perform phase retrieval by cross-correlation. Below two signals may be used, where ƒ is the signal frequency, A and B are signal magnitude, and φ and φ₀ are unknown phases.

$$monitoring signal : s ( t , ϕ ) = A . f ( 2 π ft + ϕ ) \qquad [ 1 ]$$

$$reference signal : g ( t , {ϕ}_{0} ) = B . f ( 2 π ft + {ϕ}_{0} ) \qquad [ 2 ]$$

A correlation function (ƒ) may be defined as below, where n is the number of cycles (periods) used to evaluate the integral, τ is the start time for the correlation, and θ is a free parameter of the reference signal, g(t, φ₀+θ), that is varied to determine the relative phase between the monitoring signal and the reference signal. The free parameter (θ) may be additional phase introduced to the reference signal to determine the relative phase between the monitoring signal and the reference signal.

$$I ( θ ) = {\int }_{τ}^{τ + n / f} s ( t , ϕ ) g ( t , {ϕ}_{0} + θ ) dt \qquad [ 3 ]$$

The correlation function may be maximized when the phases match:

$${ϕ}_{0} + θ = ϕ ( modulo 2 π ) \qquad [ 4 ]$$

The relative phase between the monitoring signal and the reference signal may be determined by varying the free parameter (θ) of the reference signal to maximize the correlation function, such that:

$$arg {max}_{θ} I ( θ ) = ϕ - {ϕ}_{0} mod ( 2 π ) \qquad [ 5 ]$$

When the base signal ƒ is a sine function, the correlation function may be reduced to below, where n is the number of cycles (correlation length) used to evaluate the correlation function:

$$I ( θ ) = \frac{n}{2 f} cos ( ϕ - {ϕ}_{0} - θ ) \qquad [ 6 ]$$

The free parameter (θ) of the reference signal may be varied to lock the phase of the monitoring signal. The free parameter (θ) of the reference signal may be varied until the correlation function is maximized. The free parameter (θ) of the reference signal that maximizes the correlation function may be equal to the relative phase (φ−φ₀), the difference between the phase of the monitoring signal (monitoring wave) and the phase of the baseline signal (baseline wave).

The size of the correlation length may be increased to increase the sensitivity of the phase-sensitive detection tool to the phase of the seismic waves received by the seismic receivers 15. In the presence of noise, the number of cycles used to evaluate the correlation function may be increased to improve the accuracy of the retrieved relative phase (φ−φ₀). The correlation length may be increased to mitigate signals contaminated with noise. The accuracy of the retrieved relative phase may be further improved by finding one of the zero crossings of l instead of its maximum such that:

$${arg}_{θ} ( I ( θ ) = 0 ) = ϕ - {ϕ}_{0} - \frac{π}{2} mod ( 2 π ) \qquad [ 7 ]$$

If the phase of the monitoring signal varies over time, the relative phase may be evaluated using equation 5 or 7 as a function of τ. The phase-sensitive detection tool may accurately identify phase variations in the monitoring signal as long as the phase variations occur on a time scale longer than the correlation length n/ƒ.

The property component 104 may be configured to determine changes in one or more properties of the subsurface region. Determining a change in a property of a subsurface region may include ascertaining, approximating, calculating, establishing, estimating, finding, identifying, obtaining, performing, predicting, quantifying, and/or otherwise determining the change in the property of the subsurface region. The property component 104 may be configured to determine locations of changes (e.g., position, size, shape) in the propert(ies) of the subsurface region. The property component 104 may be configured to determine characteristics of changes in the propert(ies) of the subsurface region (e.g., determining the type of change and/or the amount of change in a property of the subsurface region). A property of a subsurface region (a subsurface property) may refer to property (e.g., characteristic, trait) of materials in the subsurface region. For example, properties of a subsurface region may include rock properties and/or other properties of the subsurface region. Changes in rock properties of the subsurface region may be determined. Other changes in subsurface properties are contemplated.

Changes in the propert(ies) of the subsurface region may be caused by one or more activities in the subsurface region (activities that impact the subsurface region, activities performed on top of the subsurface region, activities performed within the subsurface region). For example, changes in the propert(ies) of the subsurface region may be caused by fluid injection and/or other operations. In some implementations, the fluid injection may include hydraulic stimulation. Hydraulic stimulation may create fractures in rock formations inside the surface region. Determining changes in the propert(ies) of the subsurface region may include locating and quantifying fractures in the subsurface region (e.g., is a fracture opening or closing, is fluid flowing through a fracture, is pore pressure changing inside a fracture, is fluid content changing inside a fracture, is water saturation changing inside a fracture). As another example, changes in the propert(ies) of the subsurface region may be caused by water sweeping. Determining changes in the propert(ies) of the subsurface region may include locating and quantifying fluid in the subsurface region (e.g., where and how water/oil is moving within the subsurface region).

The changes in the propert(ies) of the subsurface region may be determined based on the phase variations in the seismic waves (e.g., monochromatic waves) received by the seismic receivers 15 and/or other information. The changes in the propert(ies) of the subsurface region may be determined based on changes in the relative phase between the monitoring signal and the reference signal over time and/or other information. Different subsurface properties may have different effects on the speed at which seismic waves travel through the subsurface region. Changes in the wave speed may be measured by time shifts. Phase variations (Δφ) in the seismic waves may be converted to time shifts (Δt) via the relationship Δφ=2πfΔt. The time shifts may be converted into wave speed variations. The wave speed variations may be used to determine subsurface properties/changes in subsurface properties. The correspondence between wave speed variations and subsurface properties/changes in subsurface properties may be specific to the reservoir. The locations of changes may be determined using locations of phase variations. The amount/type of changes may be determined based on the magnitude of phase variations.

In some implementations, production in the subsurface region may be facilitated based on changes in propert(ies) of the subsurface region and/or other information. Changes in propert(ies) of the subsurface region may be used to develop the subsurface region (e.g., determine number, types, and/or locations of equipment to be installed in the reservoir, plan well completion) and/or perform production in the subsurface region (e.g., determine how wells are operated for production). Changes in propert(ies) of the subsurface region may be used to anticipate risks/changes in risks as operations are performed. Real-time monitoring of changes in subsurface propert(ies) may be used to perform real-time changes in operations for development and/or production. For example, a fracture operation may be performed in a subsurface region. Fractures created in the subsurface region may be determined and used to design/change one or more fracture operations (e.g., dynamically change how a fracture operation is being performed; used results of a fracture operation to design a different fracture operation).

For example, the phase variations in the seismic waves may be translated into variations in compressional and/or shear wave speed. Changes in wave speed may be translated into rock properties, such as pore pressure, fluid saturation, fracture density, and/or state of stress. Changes in rock properties may be used to change operations in the subsurface region. For example, changes in rock properties may be used to change fluid injection rates, hydraulic simulation, and/or well completion design. Changes in rock properties may be used to update subsurface models (e.g., reservoir models) and production forecast from the subsurface region.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

As used herein, the phrase “configured to” is intended to be interpreted broadly, as “being capable of or suitable for performing” some function or feature, without requiring any adaptations to provide said function or feature.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

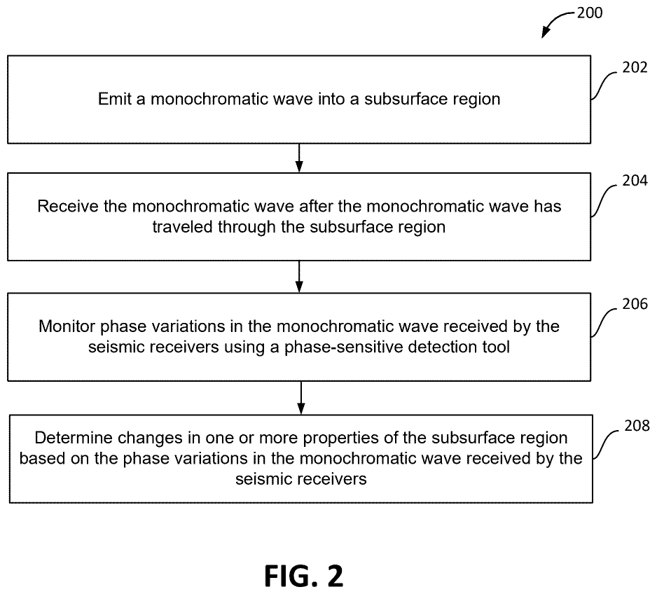

FIG. 2 illustrates method 200 for monitoring subsurface properties. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

At operation 202, a monochromatic wave may be emitted into a subsurface region. In some implementations, operation 202 may be performed by a component the same as or similar to the seismic source(s) 14 (Shown in FIG. 1 and described herein).

At operation 204, the monochromatic wave may be received after the monochromatic wave has traveled through the subsurface region. In some implementations, operation 204 may be performed by a component the same as or similar to the seismic receivers 15 (Shown in FIG. 1 and described herein).

At operation 206, phase variations in the monochromatic wave received by the seismic receivers may be monitored using a phase-sensitive detection tool. In some implementations, operation 206 may be performed by a processor component the same as or similar to the phase component 102 (Shown in FIG. 1 and described herein).

At operation 208, changes in one or more properties of the subsurface region may be determined based on the phase variations in the monochromatic wave received by the seismic receivers and/or other information. In some implementations, operation 208 may be performed by a processor component the same as or similar to the property component 104 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementations.

What is claimed is:

1. A system for monitoring subsurface properties, the system comprising:
a seismic source configured to emit a monochromatic wave into a subsurface region;
seismic receivers configured to receive the monochromatic wave after the monochromatic wave has traveled through the subsurface region; and
one or more physical processors configured by machine-readable instructions to:
monitor phase variations in the monochromatic wave received by the seismic receivers using a phase-sensitive detection tool; and
determine changes in one or more properties of the subsurface region based on the phase variations in the monochromatic wave received by the seismic receivers.

2. The system of claim 1, wherein locations of the changes in the one or more properties of the subsurface region are determined.

3. The system of claim 2, wherein characteristics of the changes in the one or more properties of the subsurface region are determined.

4. The system of claim 1, wherein the one or more properties of the subsurface region include rock properties of the subsurface region.

5. The system of claim 1, wherein the changes in the one or more properties of the subsurface region are caused by fluid injection.

6. The system of claim 5, wherein the fluid injection includes hydraulic stimulation.

7. The system of claim 1, wherein production in the subsurface region is facilitated based on the changes in the one or more properties of the subsurface region determined based on the phase variations in the monochromatic wave received by the seismic receivers.

8. The system of claim 1, wherein the seismic receivers are positioned vertically and/or horizontally within the subsurface region.

9. The system of claim 1, wherein the use of the phase-sensitive detection tool to monitor the phase variations in the monochromatic wave received by the seismic receivers includes variation in phase of a reference signal to lock phase of the monochromatic wave received by the seismic receivers.

10. The system of claim 1, wherein the use of the phase-sensitive detection tool to monitor the phase variations in the monochromatic wave received by the seismic receivers includes an increase in size of a correlation length to increase sensitivity to phase of the monochromatic wave received by the seismic receivers.

11. A method for monitoring subsurface properties, the method comprising:
emitting, via a seismic source, a monochromatic wave into a subsurface region;
receiving, via seismic receiver, the monochromatic wave after the monochromatic wave has traveled through the subsurface region; and
monitoring, via one or more processors, phase variations in the monochromatic wave received by the seismic receivers using a phase-sensitive detection tool; and
determining, via the one or more processors, changes in one or more properties of the subsurface region based on the phase variations in the monochromatic wave received by the seismic receivers.

12. The method of claim 11, further comprising determining, via the one or more processors, locations of the changes in the one or more properties of the subsurface region.

13. The method of claim 12, further comprising determining, via the one or more processors, characteristics of the changes in the one or more properties of the subsurface region.

14. The method of claim 11, wherein the one or more properties of the subsurface region include rock properties of the subsurface region.

15. The method of claim 11, wherein the changes in the one or more properties of the subsurface region are caused by fluid injection.

16. The method of claim 15, wherein the fluid injection includes hydraulic stimulation.

17. The method of claim 11, further comprising facilitating production in the subsurface region based on the changes in the one or more properties of the subsurface region determined based on the phase variations in the monochromatic wave received by the seismic receivers.

18. The method of claim 11, wherein the seismic receivers are positioned vertically and/or horizontally within the subsurface region.

19. The method of claim 11, wherein using the phase-sensitive detection tool to monitor the phase variations in the monochromatic wave received by the seismic receivers includes varying phase of a reference signal to lock phase of the monochromatic wave received by the seismic receivers.

20. The method of claim 11, wherein using the phase-sensitive detection tool to monitor the phase variations in the monochromatic wave received by the seismic receivers includes increasing size of a correlation length to increase sensitivity to phase of the monochromatic wave received by the seismic receivers.
